(19) United States
(12) Patent Application Publication
(10) Pub. No.: US 2018/0351227 A1
(43) Pub. Date: Dec. 6, 2018

(54) RADIO-FREQUENCY COMPONENT

(71) Applicant: AMPAS GMBH, 71577 Großerlach (DE)

(72) Inventor: Wolfgang ARNOLD, Großerlach (DE)

(73) Assignee: AMPAS GMBH, 71577 Großerlach (DE)

(21) Appl. No.: 15/571,827

(22) PCT Filed: Apr. 28, 2016
(86) PCT No.: PCT/EP2016/059501

§ 371 Date: Feb. 19, 2018

(30) Foreign Application Priority Data
May 8, 2015 (DE) 10 2015 107 209.2

(51) Int. Cl. H01P 3/12; H01P 1/38; H01P 1/207; H01P 3/13; H01P 11/00

(52) U.S. Cl. CPC H01P 3/12; H01P 1/38; H01P 11/002; H01P 3/13; H01P 1/207

(57) ABSTRACT

A high-frequency component for guiding electromagnetic high-frequency waves includes a hollow conductor structure with a housing and a field-guiding region. The housing includes at least in part plastics material and the housing wall surface facing the field-guiding region includes a metal coating. Two or more parallel-guided cooling ducts can be integrated into the housing, the mutual spacing of which varies in accordance with a field density of an energy-guiding mode.

### BACKGROUND AND SUMMARY

The invention relates to a high-frequency component for guiding electromagnetic high-frequency waves, comprising a hollow conductor structure with a housing and a field-guiding region, in which the housing comprises or consists at least in part of plastics material and the housing wall surface facing the field-guiding region comprises a metal coating.

A large number of waveguide structures, for guiding electromagnetic high-frequency waves are known from the prior art which may for example take the form of hollow conductor structures, microstrip structures or coaxial cables.

Microstrip and coaxial conductor structures may be used to conduct both DC currents and TEM waves and also electromagnetic waves which may have an electric field component in the direction of propagation.

Hollow conductor structures serve to guide high-energy high-frequency powers, in which at least one electrical or one mimetic component points in the direction of propagation and which are conventionally designated TE or TM waves. Such structures are not suitable for transmitting DC currents. The fundamental wave of these structures has a frequency range, the wavelength of which is of the order of magnitude of the component dimensions of the waveguide structure.

Such waveguides are used in particular in the frequency range from 1 GHz to 20 GHz, wherein it is known in the art to construct hollow conductors with a metallic housing wall and to provide these as closed tubes of rectangular, circular or elliptical cross-section. With such hollow conductors, in the stated frequency range large electrical energies may be transmitted with lower losses than with electric cables, since ohmic losses play virtually no part. Hollow conductors are used in particular to transmit transmit or receive powers from radio installations with high gain antennas, but they are also used in high energy physics, accelerator technology, in radar or in other fields in which electromagnetic energy of the highest frequency are used. In practice, hollow conductors are also used for example in microwave ovens, and are found not only in radar devices or particle accelerators but also in space travel, e.g. in satellites or spacecraft, in order to be able to transmit HF power for a radio link.

Such hollow conductors are conventionally made from metal, in particular from copper or copper-coated sheet metal alloys, which on the one hand is relatively expensive and on the other hand can only be used with difficulty to produce arbitrarily shaped hollow conductor structures. The production of metallic hollow conductors is thus associated with high costs, and minor structural details are very complex to produce. Moreover, the weight of such hollow conductor structures is considerable and leads on the one hand to extra structural expenditure and on the other hand in space travel to an increased spacecraft launching weight.

This has led to attempts to make hollow conductors at least in part from non-metallic materials, such as for example plastics material, and to make the surface of the hollow conductor housing facing the field-guiding region electrically or electrochemically conductive, in order ire particular to apply a metal coating for example of copper, silver or gold.

DE 25 40 950 A1, from which such hollow conductors with a brass, copper or silver coating are known, is mentioned here by way of example. In contrast to metallic hollow conductors, plastics hollow conductors are relatively poor at dissipating heat, resulting in the risk of undesired heating and deformation of or damage to the plastics wall. It is thus explicitly proposed in DE 25 40 950 A1 to use plastics elements, which may be appropriately metallised, for thermal separation of different regions of a high-frequency component.

DE 36 33 910 A1 describes a high-frequency component with a cooled ferrite structure in which a plurality of ferrite beads arranged in layers are held inside a plastics housing. To this end, a dielectric cylinder is provided, which encloses the cylindrical ferrite beads and passes a coolant through the ferrite elements.

Furthermore, DE 11 2011 104 333 T5 discloses a high-frequency component for forming a hollow conductor structure which, due to its low weight, is particularly suitable for use in space travel. To this end, it is proposed that an organic or metallic foam be used to form a hollow conductor structure housing, wherein for example polyester or photoresist may be used to form the open-pored structure. Silver plating may moreover be provided on the housing inner surface to guide the electromagnetic fields.

In addition, U.S. Pat. No. 5,398,010 A proposes a high-frequency component in which a hollow conductor structure is formed from thermoplastic structural components which are coated using an electrodeless copper plating method.

The above-mentioned publications thus propose high-frequency components of a thermally relatively poorly conducting plastics material, wherein no satisfactory cooling option is available in the event of heating. Heating may change the mechanical dimensions, such that electromagnetic waveguide characteristics are negatively affected. Overheating may lead to damage and to failure of the component.

On the other hand, hollow conductor structures of plastics material allow the provision of complex, fine structures which use relatively little material, are inexpensive and in particular enable lightweight structures which may for example be used in space travel or in fragile structures.

On the basis of the known prior art, it is desirable to provide a high-frequency component which, with low intrinsic weight, is able to guide high-energy electromagnetic fields and at the same time displays only a slight tendency to heating.

It is also desirable to provide high-frequency components which can be produced inexpensively, may comprise delicate structures and are of low weight, such that they may be used in applications in which it has otherwise only been possible to use relatively expensive metallic hollow conductor structures.

According to an aspect of the invention, a high-frequency component for guiding electromagnetic high-frequency waves is proposed which comprises a hollow conductor structure having a housing and a field-guiding region. The housing comprises or consists at least in part of plastics material, and the housing wall surface facing the field-guiding region comprises a metal coating, which may comprise or consist for example of copper, silver or brass. It is proposed to integrate two or more parallel-guided cooling ducts into the housing, the mutual spacing dc of which is selected in accordance with a field density of an energy-guiding mode.

By means of the cooling ducts, air, oil or water or another heat-conducting fluid for example may flow in the housing wall, and heat, which arises for example through eddy-current losses in the metal coating, may be carried away. Heating of the component is thus prevented, and thermally induced mechanical changes to the hollow conductor dimensions may for example be counteracted. The metallic hollow conductors known from the prior art lose their shape on heating, such that their tuning frequency changes and wakefields occur, for example, and cause elevated losses. In particular in the case of accelerator structures such as cavities, efficiency is markedly reduced. Through the integration of at least one cooling duct into a plastics housing wall, temperature regulation of the hollow conductor structure may be achieved, such that the temperature of the high-frequency component may be controlled and thermal changes may be counteracted. This allows better efficiency and lower electromagnetic losses to be achieved.

According to the invention, two or more parallel-guided cooling ducts are integrated into the housing, the mutual spacing dc of which is selected in accordance with a field density of an energy-guiding mode. As a rule, a fundamental mode or a higher mode is guided in a hollow conductor structure as the energy-transferring electromagnetic mode. This may be a TE or TM mode, which comprises higher electrical and magnetic field components at predefined regions than at other regions. In the case of fundamental modes in particular, strong electric and/or magnetic fields arise in the central regions of the housing wall, such that higher thermal losses arise there than at the side edges. In the case of higher modes, for example TE or TM modes with cardinal numbers >2, i.e. TExy or TMxy modes with x, y>2, greater thermal losses also occur in the regions close to the housing edges of the hollow conductor structure. When designing a hollow conductor structure, it is known in advance which energy-transferring mode is to be excited and guided. Accordingly, cooling ducts may be provided closer together in that region than in the regions in which little or no field occurs in the field-guiding region. In this way, selective temperature regulation may be achieved together with improved cooling capacity and lower cooling medium usage, such that a weight-saving power-transmitting hollow conductor structure may be provided.

In one advantageous further development, the geometric centre point of a cross-section through the cooling duct(s) may be arranged within 50% of the housing wall thickness dw, preferably within 40% of the housing wall thickness dw, starting from the metal coating. In this further development it is proposed that the cooling ducts are placed in the vicinity of the housing wall thickness and not in the centre of the housing wall. Heating occurs in particular in the metal coating as a result of eddy current losses, i.e. the undesired incoupling of currents into the housing wall, which lead to ohmic losses and thus to heating due to their limited conductivity. This heating drains energy from the electromagnetically guided wave. By placing the coolant ducts in the vicinity of the metal coating, i.e. by not arranging the cooling ducts centrally in the centre of the housing wall but rather closer to the metal coating, improved cooling capacity may be achieved.

In one advantageous further development of the invention, the housing may be produced using a 3D printing method. The plastics material used may preferably be ABS (acrylonitrile-butadiene-styrene copolymer), PLA (polylactide), PVA (polyvinyl alcohol), PC (polycarbonate), nylon, or PPSF/PPSU (polyphenylsulfone). As a result of the ongoing technologisation of plastics manufacture, plastics objects of any desired shape and size may be produced using inexpensive 3D printers. In particular, delicate hollow conductor structures in which filter elements or ferrites for example are positioned at certain points, may be produced very simply using 3D printers. In this respect, the above-mentioned types of plastics material are suitable as 3D-printable plastics for forming the housing wall of a hollow conductor structure. This may be subsequently metallised by electroplating or likewise by means of a 3D printing method, for example by applying metal powder to the housing inner wall and sintering it, for example laser sintering it, to form a hollow conductor structure. Water cooling elements, tuning elements, plates for ferrites, etc. may for example be introduced into the hollow conductor structure using 3D printing methods. The structures may be printed directly in plastics material and then coated with metal. The metal coating may be made thicker by electroplating, in order achieve the necessary current carrying capacity. To this end, structures may in particular be formed which are able to guide electromagnetic waves well right into the megawatt range. Eddy current losses are minimised by relatively thin magnetisation.

In one advantageous further development, at least one magnetisable ferrite element may be arranged in the hollow conductor structure. By means of a ferrite element, electromagnetic fields may for example be deflected or certain modes damped, since ferrites are magnetically highly conductive and thus influence the magnetic components of the electromagnetic wave. To magnetise these ferrites, external magnetic field-generating means may be provided. Typical hollow conductor structures have magnetically highly conductive surfaces of iron, such that magnetic fields can be coupled into the interior of the hollow conductor only with heavy losses. By means of a plastics hollow conductor, magnetic fields may enter the interior of the hollow conductor virtually unhindered, wherein the magnetisation brings about only a slightly weakening or influencing of the externally incoupled magnetic fields. Thus, structures containing ferrites or dielectrics in particular may be influenced very simply into a hollow conductor structure by means of external magnetic or electric fields, in order to provide field-controlling effects.

In one further development the above-mentioned embodiment, the ferrite element may be arranged on a plastics holder. The position, arrangement and orientation of the ferrite elements are particularly crucial in the event of use as a filter component or circulator. To this end, plastics holders may be provided in the plastics wall, in order to be able to arrange ferrite elements precisely at predefined positions in the field-carrying region. These may be produced very simply, in particular using a 3D plastics printing method.

Advantageously, the thickness dn of the metal coating may be reduced in the region between ferrite element and a housing wall, in particular in the peripheral region of the plastics holder, relative to the other wall regions and constitute at least 70% or less of the thickness of the metal coating of the other wall regions. This makes it possible purposefully to reduce the thickness of the metal coating in the region of the ferrites, so as to be able to couple in externally uncoupled magnetic fields unhindered into the field-guiding region and thus into the ferrite. In this way, the ferrite property is markedly improved and a circulator or a filter element has markedly better power values than in the case of a hollow conductor structure of metal.

In one equivalent aspect, use of such a high-frequency component as a circulator or RF filter is proposed, since such components comprise delicate structures which may be very inexpensively and simply implemented for high energy applications in particular by using plastics material, in particular plastics housings with fluid-guided cooling ducts.

### BRIEF DESCRIPTION OF THE DRAWINGS

Further advantages are revealed by the present description of the drawings. The drawings show exemplary embodiments of the invention. The drawings, description and claims contain numerous features in combination. A person skilled in the art will expediently also consider the features individually and combine them into meaningful further combinations.

In the drawings:

FIG. 1 is a schematic representation of a section through a high-frequency component of a first embodiment of the invention;

FIG. 2 is a schematic representation of a section through a ferrite-containing hollow conductor structure of a second exemplary embodiment of the invention with external magnetic field generation;

FIG. 3 is a sectional representation of a further exemplary embodiment of a high-frequency component according to the invention;

FIG. 4 shows sectional representations of a circulator of one embodiment of the invention.

In the figures identical elements are labelled with identical reference signs.

### DETAILED DESCRIPTION

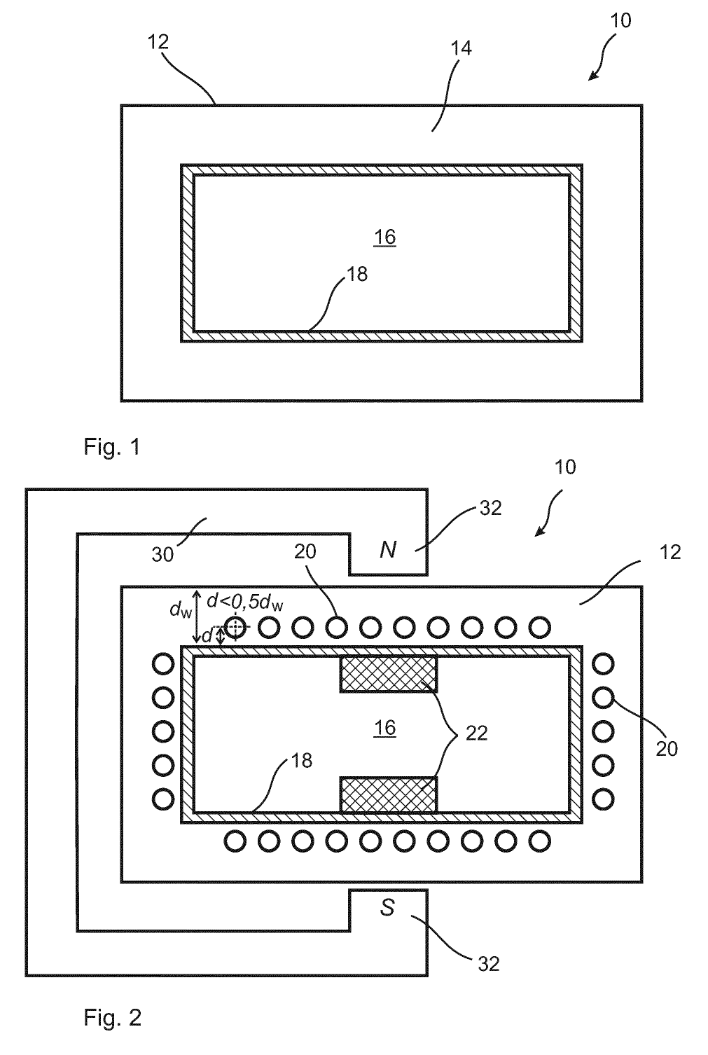

FIG. 1 is a cross-sectional representation of a first exemplary embodiment of a high-frequency component 10. The high-frequency component 10 corresponds to a rectangular hollow conductor 12, which comprises a plastics housing 14 and an internal metal coating 18, wherein the metal coating 18 completely encloses the field-guiding region 16. The TE or TM waves propagating in the field-guiding inner region 16 are bounded at the edge by the metal coating 18 in such a way that tangential electric fields cannot have any component at the metal coating. This defines propagation of at least one fundamental mode and higher modes which guide energy along the longitudinal extent of the high-frequency component. In the prior art, the housing 14 is fundamentally made from metal, resulting in high heat conductivity, high weight, high component costs and mechanical deformation in the event of increased temperature. Through induced eddy currents in the wall, heat arises, so distorting the mechanical dimensions. Moreover, a metallic housing wall of the high-frequency component 10 renders manufacture expensive, and increases the total weight of the component 10.

In the embodiment shown, the housing wall 14 is made of plastics material, and only a small surface region of the plastics wall 14 facing the field-guiding region 16 is metallised with a copper, gold or silver or brass coating, in order to ensure field guidance of the electromagnetic field.

FIG. 2 shows a further exemplary embodiment of a ferrite-containing or lossy waveguide of a high-frequency component 10. Once again, the high-frequency component 10 comprises or consists of a hollow conductor structure 12, which comprises a housing 14 and an inner metal coating layer 18 bounding the field-guiding region 16. The housing wall 14 comprises a series of cooling ducts 20, which extend both in the bottom and top regions and at the vertical side walls of the housing 14. The cross-section of the cooling ducts 20 is circular, wherein air, water, oil or another heat-conveying fluid may be passed through the ducts in order to be able to dissipate heat arising through eddy current losses in the metal coating 18, and so to regulate within limits heating of the high-frequency component 10.

Ferrite elements 22, which may exhibit high magnetic permeability, and which may purposefully influence mode propagation in the field-guiding region 16, are arranged directly on the metal coating 18 of the housing wall 14. The ferrite or electret elements 22 may be deliberately used to suppress individual modes, and control the direction of propagation of the electromagnetic wave in the field-guiding region 16.

To premagnetise the ferrite elements 22, an external magnetic field generating means 30 in the form of a permanent magnet with pole pieces 32 is provided. The magnetic field generating means 30 generates a static permanent magnetic field through the field-guiding region 16 and aligns the elementary magnets in the ferrite elements 22 such that specific premagnetisation can be established. Conventionally, metallic housing walls of a hollow conductor structure conduct the magnetic fields away due to elevated permeability in such a way that only a small proportion of the external magnetic field can be coupled in in the field-guiding region 16. The plastics material of the housing wall 14 may comprise or consist of a diamagnetic or paramagnetic material, such that magnetic fields may penetrate virtually unhindered through the hollow conductor structure 12 in order to saturate the ferrite elements 22. Thus, significantly weaker external magnetic fields of the magnetic field generating means 30 may be coupled in. In this way, the electromagnetic field may be specifically influenced with less effort. In turn, the total weight of the high-frequency component 10 is reduced. The relatively thin metal coating 18 thus serves merely in electromagnetic bounding of the field and is present in such a thickness that eddy currents are effectively suppressed and boundary conditions of the electric field may be predetermined. The metal coating has virtually no effect on magnetic field guidance with regard to activating the ferrites.

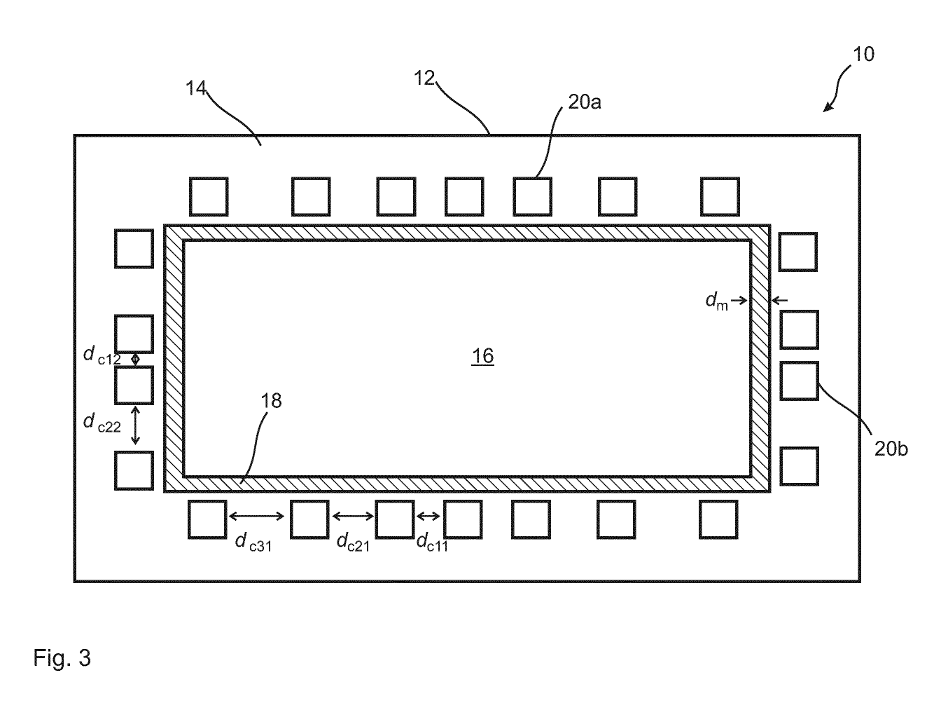

FIG. 3 shows a further exemplary embodiment of a high-frequency component 10 in the form of a rectangular waveguide. The high-frequency component 10 comprises a hollow conductor structure 12 having a housing 14 of plastics material, wherein the internal housing wall is lined with a metal coating layer 18 of copper, silver, brass or gold facing the field-guiding region 16. The magnetisation layer 18 comprises a metal coating thickness of dm. In the housing wall 14 rectangular cooling ducts 20a are arranged at the horizontal boundary faces and 20b at the vertical boundary faces for cooling purposes. The cooling ducts 20a of the horizontal boundary wall exhibit the spacings dc11, dc21, dc31. The spacings of the cooling ducts 20a, 20b are selected to correspond to the tangential electric field distribution along the housing wall with which the fundamental wave propagates in the hollow conductor structure, such that in the regions in which stronger eddy currents are to be expected due to the existence of higher electric edge fields, the density of the cooling ducts is higher than in field-free regions. Cooling ducts 20b are accordingly arranged at the vertical wall regions with the spacings dc21 and dc22, in order to ensure more effective cooling of the housing regions at those points at which higher eddy currents occur and accordingly heat the metal coating layer 18 to a greater extent.

In this way, it is possible, by arranging the cooling ducts suitably in the plastics housing wall 14, to ensure the achievement with little effort of an improved cooling effect of the hollow conductor structure in particular in the event of conveying high-energy electromagnetic waves into the megawatt range.

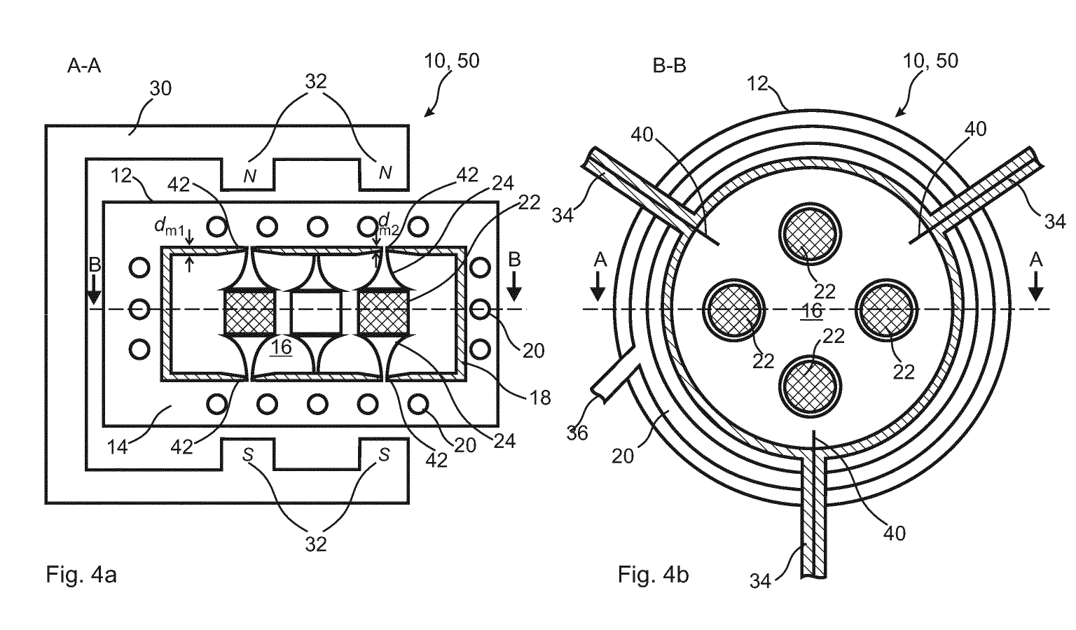

FIGS. 4a and 4b show vertical and horizontal sectional representations of a circulator according to a further embodiment of the invention. The circulator 50 in the form of high-frequency component 10 comprises a circular-cylindrical housing 14 of a hollow conductor structure 12, wherein the housing 14 is made from a plastics material. The housing 14 is built up in a 3D printing method for example by sintering or using a layer-by-layer technique. The housing 14 comprises circular cooling ducts 20, as shown in the horizontal section B-B through a cooling duct 20 of the vertical housing wall. The cooling duct 20 comprises a fluid duct connection 36 to the outside, wherein the fluid ducts may be connected together in the housing wall 14 in order for example to convey water flowing therethrough. The cooling ducts 20 are arranged in such a way in the housing wall 14 that they lie 30% closer to the metal coating layer 18 than to the outer housing wall, in order effectively to absorb heat arising in the metal coating layer 18.

Plastics holders 24 are moulded integrally onto the housing wall 14 in order to be able to accommodate pot-shaped ferrite elements 22. The plastics holders 24 are moulded both on the lower and on the upper horizontal housing wall, and enclose the pot-shaped ferrite elements 22 which are arranged in form-fitting manner in the middle. The inner housing wall region of the housing 14 is surrounded with a metal coating 18, which is thinner in the regions in which the plastics holders 24 project out of the housing wall 14, wherein these thinner metal coating portions 42 are provided in the regions below and above the ferrite elements 22. The thinner portions 42 of the metal coating 18 define incoupling points for an external magnetic field for premagnetisation of the ferrite elements 18, such that incoupling of the magnetic field is made easier at this point, and the ferrite elements may be saturated with a low external magnetic field. This therefore simplifies influencing of the internal electromagnetic field in the field-guiding region 16.

An external magnetic field generating means 30 comprises a plurality of pole piece arrangements 32 on the top and bottom of the housing wall of the housing 14, in order to be able to couple magnetic fields into the ferrite elements 22 in the vertical direction at the corresponding points. As a result of the thinner metal coating 42 in the region of the plastics holders 24 and the magnetically neutral property of the plastics material which is contained in the housing wall 14, external electric car magnetic fields may be easily coupled in to influence ferrite or dielectric elements.

The cooling ducts 20 may be arranged at different spacings from one another in the vertical and horizontal housing walls in accordance with the modes arising.

Electromagnetic fields may be coupled into the circulator via the three coaxial incoupling means 34 offset in each case by 120°, wherein these may enter and/or exit via coaxial antennas 40.

By making the metal coating layer thinner, the external magnetic field can be in- and/or outcoupled into the hollow conductor structure without significant weakening. By making the housing wall 14 of plastics material, a lower weight is achieved, and complex cooling duct profiles 20 may be very simply provided in the plastics material.

The housing wall 14 may be produced very simply using 3D printing technology in particular in the case of complex structures. Production of the housing wall 14 using plastics printing methods and subsequent electroplating allows a significant reduction in the weight of the high-frequency components 10, which is important in particular for space travel applications.

Complex constructions such as water cooling systems, tuning elements, ferrite plates or in- and/or outcoupling structures may be produced very simply using plastics material. A metallic coating may be made thicker by electroplating, in order to achieve the necessary current carrying capacity and to keep eddy current losses correspondingly low.

### LIST OF REFERENCE SIGNS

10 High-frequency component
12 Hollow conductor structure
14 Housing
16 Field-guiding region
18 Metal coating
20 Cooling duct
22 Ferrite element
24 Plastics holder
26 Vertical housing wall
28 Horizontal housing wall
30 Magnetic field generating means
32 Pole piece
34 Coaxial coupler
36 Fluid duct connection
38 Ferrite plate
40 Coaxial antenna
42 Thinner metal coating portion
50 Circulator

1-8. (canceled)

9. A high-frequency component for guiding electromagnetic high-frequency waves, comprising a hollow conductor structure with a housing and a field-guiding region, in which the housing comprises plastics material and the housing wall surface (26, 28) facing the field-striding region comprises a metal coating, characterised in that a plurality of parallel-guided cooling ducts are integrated into the wall of the housing, the mutual spacing dc of which varies in accordance with a field density of an energy-guiding mode, and the geometric centre point of a cross-section through the plurality of cooling duct(s) is arranged within 40% of the housing wall thickness dw starting from the metal coating.

10. A high-frequency component according to claim 9, wherein the housing may be produced using a 3D printing method, wherein the plastics material is preferably ABS (acrylonitrile-butadiene-styrene copolymer), PLA (polylactide), PVA (polyvinyl alcohol), PC (polycarbonate), nylon, or PPSF/PPSU (polyphenylsulfone).

11. A high-frequency component according to claim 9, wherein at least one magnetisable ferrite element is arranged in the hollow conductor structure.

12. A high-frequency component according to claim 11, wherein the ferrite element is arranged on a plastics holder.

13. A high-frequency component according to claim 11, wherein the thickness dm of the metal coating is reduced in the region between ferrite element and a housing wall, in particular in the peripheral region of the plastics holder, relative to the other wall regions and constitutes at least 70% or less of the thickness of the metal coating of the other wall regions.

14. A circulator comprising a high frequency component according to claim 9.

15. An RF filter comprising a high-frequency component according to claim 9.
